(19) United States
(12) Patent Application Publication
(10) Pub. No.: US 2024/0170728 A1
(43) Pub. Date: May 23, 2024

(54) STRUCTURAL BATTERY FOR VEHICLE

(71) Applicants: Hyundai Motor Company, Seoul (KR); Kia Corporation, Seoul (KR)

(72) Inventor: Won Ki Song, Seongnam-si (KR)

(21) Appl. No.: 18/490,173

(22) Filed: Oct. 19, 2023

(30) Foreign Application Priority Data
Nov. 17, 2022 (KR) 10-2022-0154473

(51) Int. Cl. H01M 10/0585; B60R 16/04; H01M 4/13; H01M 4/62; H01M 4/66; H01M 50/186; H01M 50/531; H01M 50/586; H01M 50/59

(52) U.S. Cl. CPC H01M 10/0585; B60R 16/04; H01M 4/13; H01M 4/62; H01M 4/663; H01M 50/186; H01M 50/531; H01M 50/586; H01M 50/59; H01M 2004/028; H01M 2220/20

(57) ABSTRACT

An embodiment structural battery for a vehicle includes a positive electrode layer including a first carbon fiber current collecting layer and a positive electrode active material sequentially stacked from top to bottom, a negative electrode layer under the positive electrode layer and including a negative electrode active material and a second carbon fiber current collecting layer sequentially stacked from the top to bottom, upper and lower structure reinforcement layers stacked as outermost upper and lower layers above and below the positive and negative electrode layers, respectively, and solid electrolytes coating a boundary between the positive and negative electrode active materials and coating side surfaces of the positive electrode layer and the negative electrode layer, wherein the structural battery is formed by electrical connection between a positive electrode terminal connected to the positive electrode layer and a negative electrode terminal connected to the negative electrode layer.

### CROSS-REFERENCE TO RELATED APPLICATIONS

This application claims the benefit of Korean Patent Application No. 10-2022-0154473, filed on Nov. 17, 2022, which application is hereby incorporated herein by reference.

### TECHNICAL FIELD

The present invention relates to a structural battery for a vehicle.

### BACKGROUND

In general, a lithium-ion battery mounted on a vehicle makes up a significant portion of the weight of the vehicle, but it does not have any function of supporting the load.

On the other hand, a structural battery is a part that is installed on a frame or structure included in the vehicle and has both the function of supporting the load and a battery charging and discharging function. That is, the structural battery may serve as a battery while functioning as a vehicle structure.

The structural battery is also called a massless energy storage device, because when the weight of the battery becomes part of a load support structure, the weight of the battery that stores energy is essentially nonexistent. Such a multi-function battery may significantly reduce the weight of the vehicle. In a case where such a structural battery is applied to an electric vehicle, it is possible to increase a cruising distance as the weight of the electric vehicle is reduced. Furthermore, the structural battery has a lower electric energy density but has a higher stability.

As illustrated in FIG. 1, an existing structural battery for a vehicle includes structure reinforcement layers 10 and 15 stacked as the outermost upper and lower layers, respectively, and insulation/sealing layers 20 and 25 stacked on inner sides of the structure reinforcement layers 10 and 15, respectively, and cells stacked between the insulating/sealing layers 20 and 25.

At this time, the cells are formed by sequentially stacking positive electrode layers 30 and 42, electrolyte layers 62 and 64, and negative electrode layers 35 and 52 from top to bottom. The positive electrode layers 30 and 42 are formed of a positive electrode active material 42, and the negative electrode layers 35 and 52 are formed of a negative electrode active material 52. The positive electrode active material 42 is formed between sealing layers 44, and the negative electrode active material 52 is formed between sealing layers 54. Further, the electrolyte layers 62 and 64 are formed of an electrolyte 62 formed between glass fibers.

Here, the electrolyte layers 62 and 64 are formed by injecting a liquid electrolyte between the glass fibers. In this case, a separate liquid electrolyte injection process is required when manufacturing the cells. In addition, since an injection tube 70 needs to be inserted when the liquid electrolyte is injected, a structure for separating upper and lower layers is provided, and a separate sealing process is required to block an inlet of the injection tube 70 after electrolyte injection.

### SUMMARY

The present invention relates to a structural battery for a vehicle. Particular embodiments relate to a structural battery for a vehicle that may be applied as a member of a vehicle body for inter-part mechanical coupling and may be electrochemically connected to a lithium-ion battery for boosting.

Embodiments of the present disclosure provide a structural battery for a vehicle capable of having an improved mechanical strength by not requiring a liquid electrolyte injection process in manufacturing the structural battery.

A structural battery for a vehicle according to an exemplary embodiment includes a positive electrode layer formed by sequentially stacking a first carbon fiber current collecting layer and a positive electrode active material from top to bottom, a negative electrode layer formed under the positive electrode layer by sequentially stacking a negative electrode active material and a second carbon fiber current collecting layer from top to bottom, and structure reinforcement layers stacked as an outermost upper layer above the positive electrode layer and an outermost lower layer below the negative electrode layer, respectively, in which the battery is formed by electrical connection between a positive electrode terminal connected to the positive electrode layer and a negative electrode terminal connected to the negative electrode layer, and a boundary between the positive electrode active material and the negative electrode active material, side surfaces of the positive electrode active material and the first carbon fiber current collecting layer, and side surfaces of the negative electrode active material and the second carbon fiber current collecting layer are coated with solid electrolytes.

A first insulating layer may be stacked between the structure reinforcement layer as the outermost upper layer and the first carbon fiber current collecting layer, and a second insulating layer may be stacked between the second carbon fiber current collecting layer and the structure reinforcement layer as the outermost lower layer.

The first and second insulating layers may be formed of glass fiber prepreg.

The first and second insulating layers may be formed of a glass fiber material.

The structure reinforcement layers may be formed of carbon fiber prepreg.

The positive electrode terminal may be interposed between the first insulating layer and the first carbon fiber current collecting layer, and the negative electrode terminal may be interposed between the second carbon fiber current collecting layer and the second insulating layer.

Sealing layers may be applied onto side surfaces of the positive electrode layer and the negative electrode layer between the first carbon fiber current collecting layer and the second carbon fiber current collecting layer.

Sealing layers may be further stacked between the first insulating layer and the first carbon fiber current collecting layer and between the second carbon fiber current collecting layer and the second insulating layer.

The sealing layers may be formed of a SUS material.

According to embodiments of the present invention, a liquid electrolyte injection process is eliminated in manufacturing the cells of the structural battery for a vehicle, and thus, a separate sealing process for blocking an inlet of an injection tube after electrolyte injection may be omitted, thereby reducing costs.

In addition, as the side surfaces of the positive electrode layer and the negative electrode layer of the cells and the layers therebetween are coated with a solid electrolyte, an inter-layer mechanical strength of the structural battery may be improved, and the structural battery may be manufactured at a room temperature, thereby improving ease of manufacturing.

In addition, the structural battery for a vehicle according to an exemplary embodiment of the present invention not only has a battery function but also functions as a vehicle body frame, thereby enabling weight reduction and improving battery performance and increasing a cruising distance.

### BRIEF DESCRIPTION OF THE DRAWINGS

FIG. 1 is a cross-sectional view illustrating a structure of an existing structural battery for a vehicle;

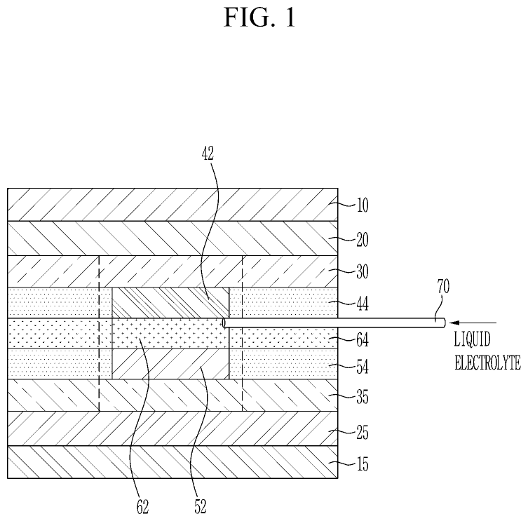

FIG. 2 is a cross-sectional view of a structural battery for a vehicle according to an exemplary embodiment of the present invention;

FIG. 3 is a cross-sectional view of a structural battery for a vehicle according to an exemplary embodiment of the present invention in which a sealing layer is added; and

FIG. 4 is a cross-sectional view of a structural battery for a vehicle according to another exemplary embodiment of the present invention in which a sealing layer is added.

### DETAILED DESCRIPTION OF ILLUSTRATIVE EMBODIMENTS

Hereinafter, several exemplary embodiments of the present invention will be described in detail with reference to the accompanying drawings so that those skilled in the art to which the present invention pertains may easily practice embodiments of the present invention. However, the embodiments of the present invention may be implemented in various different forms and are not limited to the exemplary embodiments provided herein.

In addition, in several exemplary embodiments, components having the same configuration will be representatively described using the same reference numerals in an exemplary embodiment, and only components different from those of an exemplary embodiment will be described in the other exemplary embodiments.

It is to be noted that the drawings are schematic and not drawn to scale. Relative dimensions and proportions of portions in the drawings are shown exaggerated or reduced in size for clarity and convenience in the drawings, and any dimensions are illustrative only and not limiting. Further, the same reference numerals are used to indicate similar features in the same structure, element, or part appearing in two or more drawings. When a part is referred to as being “on” another part, it may be directly on the other part or there may be other parts intervening therebetween.

Exemplary embodiments of the present invention will be described in detail. As a result, various modifications of the exemplary embodiments are expected. Therefore, an exemplary embodiment is not limited to a specific aspect of an illustrated region, and for example, includes modifications made for manufacturing.

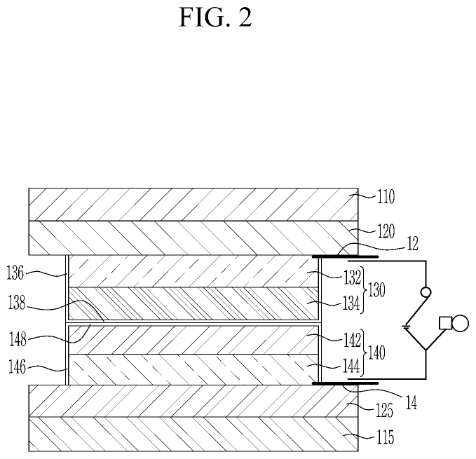

Hereinafter, a structural battery for a vehicle according to an exemplary embodiment of the present invention will be described with reference to FIG. 2.

Referring to FIG. 2, the structural battery for a vehicle according to an exemplary embodiment of the present invention includes cells in which a positive electrode layer 130 and a negative electrode layer 140 are stacked from top to bottom, a structure reinforcement layer 110 is stacked as the outermost upper layer above the positive electrode layer 130, and a structure reinforcement layer 115 is stacked as the outermost lower layer below the negative electrode layer 140.

The positive electrode layer 130 is formed by sequentially stacking a first carbon fiber current collecting layer 132 and a positive electrode active material 134 below the upper structure reinforcement layer 110, and the negative electrode layer 140 is formed under the positive electrode layer 130 by sequentially stacking a negative electrode active material 142 and a second carbon fiber current collecting layer 144.

A positive electrode terminal 12 and a negative electrode terminal 14 are respectively connected to the positive electrode layer 130 and the negative electrode layer 140, and the battery is formed by electrical connection between the positive electrode terminal 12 and the negative electrode terminal 14. The positive electrode terminal 12 is interposed between a first insulating layer 120 and the first carbon fiber current collecting layer 132, and the negative electrode terminal 14 is interposed between the second carbon fiber current collecting layer 144 and a second insulating layer 125.

The structure reinforcement layers 110 and 115 may be implemented by carbon fiber prepreg layers to improve the strength of the structural battery. The structure reinforcement layers 110 and 115 may be formed by stacking carbon fiber prepregs in multiple layers and at various angles as outer layers of the structural battery according to characteristics such as stiffness and strength required for parts. Therefore, the cells formed between the structure reinforcement layers 110 and 115 may be protected and a mechanical strength of the entire stacked structure may be improved.

Meanwhile, the first insulating layer 120 may be stacked between the outermost upper structure reinforcement layer 110 of the structural battery and the first carbon fiber current collecting layer 132, and the second insulating layer 125 may be stacked between the second carbon fiber current collecting layer 144 and the outermost lower structure reinforcement layer 115 of the structural battery.

The first insulating layer 120 and the second insulating layer 125 serve to block the positive electrode layer 130 and the negative electrode layer 140 from being electrically connected to the outside, respectively. The first insulating layer 120 and the second insulating layer 125 may be formed of glass fiber prepreg.

Meanwhile, a boundary between the positive electrode active material 134 and the negative electrode active material 142 may be coated with solid electrolytes 138 and 148, side surfaces of the positive electrode active material 134 and the first carbon fiber current collecting layer 132 may be coated with a solid electrolyte 136, and side surfaces of the negative electrode active material 142 and the second carbon fiber current collecting layer 144 may be coated with a solid electrolyte 146. Such a structure is obtained by eliminating glass fiber prepregs of a positive electrode layer and a negative electrode layer from the stacked structure of an existing structural battery and eliminating a liquid electrolyte layer formed between a positive electrode active material and a negative electrode active material.

In such a structure, when the battery is charged, lithium in the positive electrode active material 134 is separated into lithium ions and electrons. The lithium ions move to the negative electrode active material 142 through the solid electrolytes 138 and 148 coating the boundary between the positive electrode active material 134 and the negative electrode active material 142, and the electrons move to the first carbon fiber current collecting layer 132 and then sequentially pass through the positive electrode terminal 12 and the negative electrode terminal 14 and move to the negative electrode active material 142 to thereby charge the battery.

On the contrary, when the battery is discharged, lithium ions in the negative electrode active material 142 move to the positive electrode active material 134 through the solid electrolytes 138 and 148 coating the boundary between the positive electrode active material 134 and the negative electrode active material 142, and electrons in the negative electrode active material 142 move to the second carbon fiber current collecting layer 144 and then sequentially pass through the negative electrode terminal 14 and the positive electrode terminal 12 and move to the positive electrode active material 134 to discharge the battery.

Since the electrons may not pass between the first carbon fiber current collecting layer 132 and the first insulating layer 120 and between the second carbon fiber current collecting layer 144 and the second insulating layer 125, the solid electrolyte coating is not applied between the first carbon fiber current collecting layer 132 and the first insulating layer 120 or between the second carbon fiber current collecting layer 144 and the second insulating layer 125.

As the solid electrolyte coating structure as described above is applied, the liquid electrolyte layer may be eliminated. As a result, a separate sealing process for blocking an inlet of an injection tube after liquid electrolyte injection may be omitted, the mechanical strength may be improved, and room-temperature manufacturing is possible, which improves ease of manufacturing.

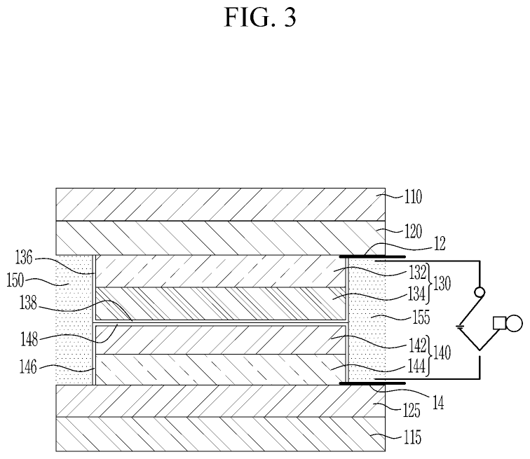

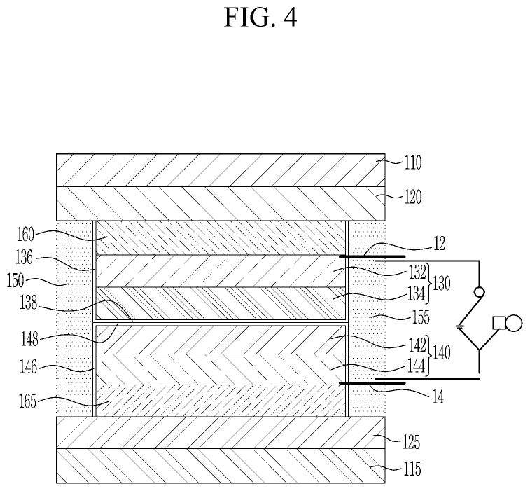

FIG. 3 is a cross-sectional view of a structural battery for a vehicle according to an exemplary embodiment of the present invention in which a sealing layer is added. FIG. 4 is a cross-sectional view of a structural battery for a vehicle according to another exemplary embodiment of the present invention in which a sealing layer is added.

As illustrated in FIG. 3, sealing layers 150 and 155 may be applied onto the side surfaces of the positive electrode layer 130 and the negative electrode layer 140 between the first carbon fiber current collecting layer 132 and the second carbon fiber current collecting layer 144. The sealing layers 150 and 155 may be formed of glass fiber prepreg and may further enhance a sealing function of preventing direct contact with external moisture, air, and the like together with the coating with the solid electrolytes 136 and 146 on the side surfaces of the positive electrode layer 130 and the negative electrode layer 140.

Further, as illustrated in FIG. 4, sealing layers 160 and 165 may be further stacked between the first insulating layer 120 and the first carbon fiber current collecting layer 132 and between the second carbon fiber current collecting layer 144 and the second insulating layer 125. The sealing layers 160 and 165 may be formed of a SUS material. The sealing layers 160 and 165 may further enhance a sealing function of preventing direct contact with external moisture, air, and the like together with the coating with the solid electrolytes 136 and 146 on the side surfaces of the positive electrode layer 130 and the negative electrode layer 140, an upper surface of the positive electrode layer 130, and a lower surface of the negative electrode layer 140.

As described above, according to embodiments of the present invention, a liquid electrolyte injection process is eliminated in manufacturing the cells of the structural battery for a vehicle, and thus, a separate sealing process for blocking an inlet of an injection tube after electrolyte injection may be omitted, thereby reducing costs.

In addition, as the side surfaces of the positive electrode layer and the negative electrode layer of the cells and the layers therebetween are coated with a solid electrolyte, an inter-layer mechanical strength of the structural battery may be improved, and the structural battery may be manufactured at a room temperature, thereby improving ease of manufacturing.

In addition, the structural battery for a vehicle according to an exemplary embodiment of the present invention not only has a battery function but also functions as a vehicle body frame, thereby enabling weight reduction and improving battery performance and increasing a cruising distance.

While embodiments of this invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

The following reference identifiers may be used in connection with the drawings to describe various features of embodiments of the present invention.
12: positive electrode terminal
14: negative electrode terminal
110, 115: structure reinforcement layer
120: first insulating layer
125: second insulating layer
130: positive electrode layer
132: first carbon fiber current collecting layer
134: positive electrode active material
140: negative electrode layer
142: negative electrode active material
144: second carbon fiber current collecting layer
138, 148, 136, 146: solid electrolyte
150, 155, 160, 165: sealing layer

What is claimed is:

1. A structural battery for a vehicle, the structural battery comprising:
a positive electrode layer comprising a first carbon fiber current collecting layer and a positive electrode active material sequentially stacked from top to bottom;
a negative electrode layer under the positive electrode layer and comprising a negative electrode active material and a second carbon fiber current collecting layer sequentially stacked from the top to the bottom, wherein the structural battery is provided by electrical connection between a positive electrode terminal connected to the positive electrode layer and a negative electrode terminal connected to the negative electrode layer;
upper and lower structure reinforcement layers stacked as an outermost upper layer above the positive electrode layer and an outermost lower layer below the negative electrode layer, respectively; and
solid electrolytes coating a boundary between the positive electrode active material and the negative electrode active material and coating side surfaces of the positive electrode active material, the first carbon fiber current collecting layer, the negative electrode active material, and the second carbon fiber current collecting layer.

2. The structural battery of claim 1, further comprising:
a first insulating layer stacked between the upper structure reinforcement layer and the first carbon fiber current collecting layer; and
a second insulating layer stacked between the second carbon fiber current collecting layer and the lower structure reinforcement layer.

3. The structural battery of claim 2, wherein the first and second insulating layers comprise glass fiber prepreg.

4. The structural battery of claim 2, wherein the upper and lower structure reinforcement layers comprise carbon fiber prepreg.

5. The structural battery of claim 2, wherein:
the positive electrode terminal is interposed between the first insulating layer and the first carbon fiber current collecting layer; and
the negative electrode terminal is interposed between the second carbon fiber current collecting layer and the second insulating layer.

6. The structural battery of claim 2, further comprising first sealing layers on the side surfaces of the positive electrode active material, the first carbon fiber current collecting layer, the negative electrode active material, and the second carbon fiber current collecting layer.

7. The structural battery of claim 6, wherein the solid electrolytes are disposed between the first sealing layers and the side surfaces of the positive electrode active material, the first carbon fiber current collecting layer, the negative electrode active material, and the second carbon fiber current collecting layer.

8. The structural battery of claim 2, further comprising second sealing layers stacked between the first insulating layer and the first carbon fiber current collecting layer and between the second carbon fiber current collecting layer and the second insulating layer, respectively.

9. The structural battery of claim 1, wherein the upper and lower structure reinforcement layers comprise carbon fiber prepreg.

10. The structural battery of claim 1, further comprising first sealing layers on the side surfaces of the positive electrode active material, the first carbon fiber current collecting layer, the negative electrode active material, and the second carbon fiber current collecting layer.

11. The structural battery of claim 10, wherein the solid electrolytes are disposed between the first sealing layers and the side surfaces of the positive electrode active material, the first carbon fiber current collecting layer, the negative electrode active material, and the second carbon fiber current collecting layer.

12. A structural battery for a vehicle, the structural battery comprising:
a positive electrode layer comprising a first carbon fiber current collecting layer and a positive electrode active material sequentially stacked from top to bottom;
a negative electrode layer under the positive electrode layer and comprising a negative electrode active material and a second carbon fiber current collecting layer sequentially stacked from the top to the bottom, wherein the structural battery is provided by electrical connection between a positive electrode terminal connected to the positive electrode layer and a negative electrode terminal connected to the negative electrode layer;
upper and lower structure reinforcement layers stacked as an outermost upper layer above the positive electrode layer and an outermost lower layer below the negative electrode layer, respectively, wherein the upper and lower structure reinforcement layers comprise carbon fiber prepreg; and
solid electrolytes coating a boundary between the positive electrode active material and the negative electrode active material and coating side surfaces of the positive electrode active material, the first carbon fiber current collecting layer, the negative electrode active material, and the second carbon fiber current collecting layer.

13. The structural battery of claim 12, further comprising:
a first insulating layer stacked between the upper structure reinforcement layer and the first carbon fiber current collecting layer; and
a second insulating layer stacked between the second carbon fiber current collecting layer and the lower structure reinforcement layer.

14. The structural battery of claim 13, wherein the first and second insulating layers comprise glass fiber prepreg.

15. The structural battery of claim 13, wherein:
the positive electrode terminal is interposed between the first insulating layer and the first carbon fiber current collecting layer; and
the negative electrode terminal is interposed between the second carbon fiber current collecting layer and the second insulating layer.

16. The structural battery of claim 13, further comprising first sealing layers on the side surfaces of the positive electrode active material, the first carbon fiber current collecting layer, the negative electrode active material, and the second carbon fiber current collecting layer.

17. The structural battery of claim 13, further comprising second sealing layers stacked between the first insulating layer and the first carbon fiber current collecting layer and between the second carbon fiber current collecting layer and the second insulating layer, respectively.

18. A structural battery for a vehicle, the structural battery comprising:
a positive electrode layer comprising a first carbon fiber current collecting layer and a positive electrode active material sequentially stacked from top to bottom;
a negative electrode layer under the positive electrode layer and comprising a negative electrode active material and a second carbon fiber current collecting layer sequentially stacked from the top to the bottom, wherein the structural battery is provided by electrical connection between a positive electrode terminal connected to the positive electrode layer and a negative electrode terminal connected to the negative electrode layer;
upper and lower structure reinforcement layers stacked as an outermost upper layer above the positive electrode layer and an outermost lower layer below the negative electrode layer, respectively;
solid electrolytes coating a boundary between the positive electrode active material and the negative electrode active material and coating side surfaces of the positive electrode active material, the first carbon fiber current collecting layer, the negative electrode active material, and the second carbon fiber current collecting layer;
a first insulating layer stacked between the upper structure reinforcement layer and the first carbon fiber current collecting layer;
a second insulating layer stacked between the second carbon fiber current collecting layer and the lower structure reinforcement layer;
first sealing layers on the side surfaces of the positive electrode active material, the first carbon fiber current collecting layer, the negative electrode active material, and the second carbon fiber current collecting layer; and
second sealing layers stacked between the first insulating layer and the first carbon fiber current collecting layer and between the second carbon fiber current collecting layer and the second insulating layer, respectively.

19. The structural battery of claim 18, wherein:
the first and second insulating layers comprise glass fiber prepreg; and
the upper and lower structure reinforcement layers comprise carbon fiber prepreg.

20. The structural battery of claim 18, wherein:
the positive electrode terminal is interposed between the first insulating layer and the first carbon fiber current collecting layer; and
the negative electrode terminal is interposed between the second carbon fiber current collecting layer and the second insulating layer.
